(19) United States
(12) Patent Application Publication
(10) Pub. No.: US 2006/0146235 A1
(43) Pub. Date: Jul. 6, 2006

(54) Color filter substrate for liquid crystal display and method of fabricating the same

(76) Inventors: Kwang Sik Oh, Chilgok-gun (KR); Kyo Yong Koo, Gumi-si (KR)

Correspondence Address: MCKENNA LONG & ALDRIDGE LLP, 1900 K STREET, NW, WASHINGTON, DC, 20006, US

(21) Appl. No.: 11/167,113

(22) Filed: Jun. 28, 2005

(30) Foreign Application Priority Data
Dec. 31, 2004 (KR) 10-2004-0118219

(51) Int. Cl. G02F 1/1335

(52) U.S. Cl. 349/106

(57) ABSTRACT

A color filter substrate for liquid crystal displays and a method of fabricating the same are disclosed. The color filter substrate includes a transparent insulating substrate, a black matrix, a red color filter which includes red color resin and transparent conductive material, a green color filter which includes green color resin and the transparent conductive material, and a blue color filter which includes blue color resin and the transparent conductive material. On the transparent insulating substrate and having a plurality of openings; a red color filter on one of the openings of the black matrix, wherein the red color filter includes a red color resin and a transparent conductive material; a green color filter on a second of the plurality of openings of the black matrix, wherein the green color filter includes a green color resin and the transparent conductive material; and a blue color filter on a third of the plurality of openings of the black matrix, wherein the blue color filter includes a blue color resin and the transparent conductive material.

This application claims the benefit of Korean Application No. 10-2004-0118219, filed on Dec. 31, 2004, which is hereby incorporated by reference for all purposes as if fully set forth herein.

### BACKGROUND OF THE INVENTION

1. Field of the Invention

The present invention relates to a color filter substrate for liquid crystal displays (LCDs) and a method of fabricating the same. More particularly, the present invention relates to a color filter substrate for a liquid crystal display in which transparent conductive material is included in a color filter, and a method of fabricating the same.

2. Description of the Related Art

The importance of the role of electronic displays is growing in today's information society, and various types of electronic displays have been extensively used in various industrial fields. The electronic display field has been developing more and more, and electronic displays that have improved performance capable of satisfying various demands of information society have continuously been developed. The electronic display is an electronic device that converts electronic information signals output from various types of electronic machines to light information signals that are capable of being recognized by the human eye. And, the electronic display may be considered a bridging device for connecting humans to the electronic machines.

Of the electronic displays, a display for displaying a light information signal using light emission is called a light emitting display, and another display employing light modulation by means of reflection, scattering, and interference is called a light receiving display. Examples of light emitting displays are a cathode ray tube (CRT), a plasma display panel (PDP), an organic electroluminescent display (OELD), or a light emitting diode (LED). Additionally, the light receiving display which is called a passive display may be exemplified by a liquid crystal display (LCD) or an electrophoretic image display (EPID).

Light emitting displays have been applied to televisions and computer monitors. The cathode ray tube (CRT) which is the display having the longest history has the highest market share in terms of economic efficiency, but has many disadvantages, including heavy weight, large volume, and high power consumption.

With the recent trend of voltage reduction and electric power reduction of electronic devices based on rapid advances in semiconductor technology and the recent trend toward miniaturized, slim, and light electronic machines, the demand for flat panel displays as electronic displays that are suitable for novel environments is rapidly growing. To satisfy the demand, flat panel displays, such as the liquid crystal display (LCD), the plasma display panel (PDP), or the organic electroluminescent display (OELD), has been developed. Of the flat panel displays, the liquid crystal display, which is easily made small, light, and slim and has low power consumption and low driving voltage, is being watched.

In the liquid crystal display, liquid crystal material having anisotropic dielectricity is injected between an upper transparent insulating substrate on which a common electrode, a color filter, and a black matrix are formed and a lower transparent insulating substrate on which a thin film transistor (TFT) component and a pixel electrode are formed. Different electric potentials are applied to the pixel and common electrodes to control the intensity of an electric field formed on the liquid crystal material so that the molecular arrangement of the liquid crystal material changes, thereby controlling the intensity of light penetrating the transparent insulating substrate, resulting in the display of desired images.

A description will be given of a related art liquid crystal display, with reference to FIG. 1. FIG. 1 is a sectional view of the related art liquid crystal display.

As shown in FIG. 1, the related art liquid crystal display comprises an array substrate 10 at a lower part thereof, a color filter substrate 20 at an upper part thereof, and a liquid crystal layer 30 interposed between the array substrate 10 and the color filter substrate 20.

The array substrate 10 includes a gate electrode 12 consisting of conductive material on a transparent insulating substrate 11, and a gate insulating film 13 consisting of a silicon nitride film (SiNx) or a silicon oxide film (SiO₂) covering the gate electrode 12. An active layer 14 made of amorphous silicon is formed on an upper side of the gate insulating film 13, and an ohmic contact layer 15 made of doped amorphous silicon is formed on an upper side of the active layer 14. Source and drain electrodes 16a, 16b made of conductive material are formed on an upper side of the ohmic contact layer 15. The source electrode 16a and the drain electrode 16b form a thin film transistor in conjunction with the gate electrode 12. A protective layer 17 made of a silicon nitride film, a silicon oxide film, or an organic insulating film is formed on upper sides of the source electrode 16a and the drain electrode 16b, and has a contact hole 17c so as to expose the drain electrode 16b. A pixel electrode 18 made of transparent conductive material is formed on an upper side of the protective layer 17, and connected through the contact hole 17c to the drain electrode 16b.

The color filter substrate 20 will be described with reference to FIGS. 1 and 2. FIG. 2 is a sectional view of the color filter substrate for the related art liquid crystal display.

The color filter substrate 20 is separated from the array substrate 10 by a predetermined interval, and includes a transparent insulating substrate 21. A black matrix 22 is provided on the entire surface of the transparent insulating substrate 21 so as to correspond in position to the thin film transistor component, and has openings which correspond in position to the pixel electrode 18. Accordingly, the black matrix 22 prevents light leakage caused by tilting liquid crystal molecules on a portion other than the pixel electrode 18, and blocks light incident upon the thin film transistor component, thereby preventing a photo induced leakage current from occurring. A red color filter 23a, a green color filter 23b, and a blue color filter 23c are formed on the opening of the black matrix 22, and a common electrode 24 consisting of a transparent conductive material is formed on upper sides of the red color filter 23a, the green color filter 23b, and the blue color filter 23c.

Furthermore, the liquid crystal layer 30 is injected and a column spacer 40 is provided between the color filter substrate 20 and the array substrate 1 0, so that the two substrates 10, 20 are spaced apart and a thickness of the liquid crystal layer 30 is assured.

As described above, the related art color filter substrate 20 for liquid crystal displays comprises the common electrode 24, the color filter 23, and the black matrix 22. In other words, the related art color filter substrate 20 comprises the additional common electrode 24 and color filter 23. However, if a color filter 23 is produced using a transparent conductive material, it is possible to use a color filter 23 having transparent conductive material as the common electrode even though the additional common electrode 24 is not provided on an upper side of the color filter 23.

### SUMMARY OF THE INVENTION

Accordingly, the present invention is directed to a color filter substrate for a liquid crystal display and method of fabricating the same that substantially obviate one or more of the problems due to limitations and disadvantages of the related art.

An advantage of the present invention is to provide a color filter substrate for liquid crystal displays (LCDs) in which, since transparent conductive material is included in a color filter, it is unnecessary to provide additional transparent electrodes.

Another advantage of the present invention is to provide a method of fabricating a color filter substrate for a liquid crystal display.

Additional features and advantages of the invention will be set forth in the description which follows, and in part will be apparent from the description, or may be learned by practice of the invention. These and other advantages of the invention will be realized and attained by the structure particularly pointed out in the written description and claims thereof as well as the appended drawings.

To achieve these and other advantages, and in accordance with the purpose of the present invention, as embodied and broadly described color filter substrate includes a transparent insulating substrate, a black matrix on the transparent insulating substrate and having a plurality of openings, a red color filter on one of the openings of the black matrix, wherein the red color filter includes a red color resin and a transparent conductive material, a green color filter on a second of the plurality of openings of the black matrix, wherein the green color filter includes a green color resin and the transparent conductive material, and a blue color filter on a third of the plurality of openings of the black matrix, wherein the blue color filter includes a blue color resin and the transparent conductive material.

In another aspect, the present invention provides a method of fabricating a color filter substrate for liquid crystal displays including providing a transparent insulating substrate, forming a black matrix having a plurality of openings on the transparent insulating substrate, and forming a red color filter including a red color resin and a transparent conductive material, a green color filter including a green color resin and the transparent conductive material, and a blue color filter including a blue color resin and the transparent conductive material on the openings of the black matrix.

### BRIEF DESCRIPTION OF THE DRAWINGS

The accompanying drawings, which are included to provide a further understanding of the invention and are incorporated in and constitute a part of this specification, illustrate embodiments of the invention and together with the description serve to explain the principals of the invention.

In the drawings:

FIG. 1 is a sectional view of a related art liquid crystal display;

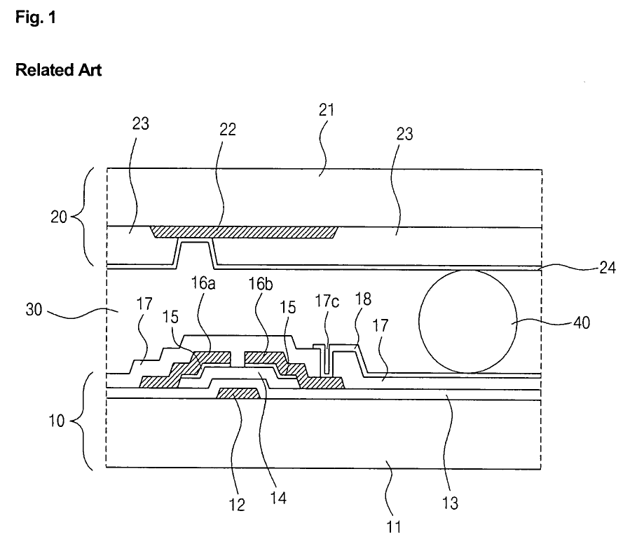

FIG. 2 is a sectional view of a related art color filter substrate for a liquid crystal display;

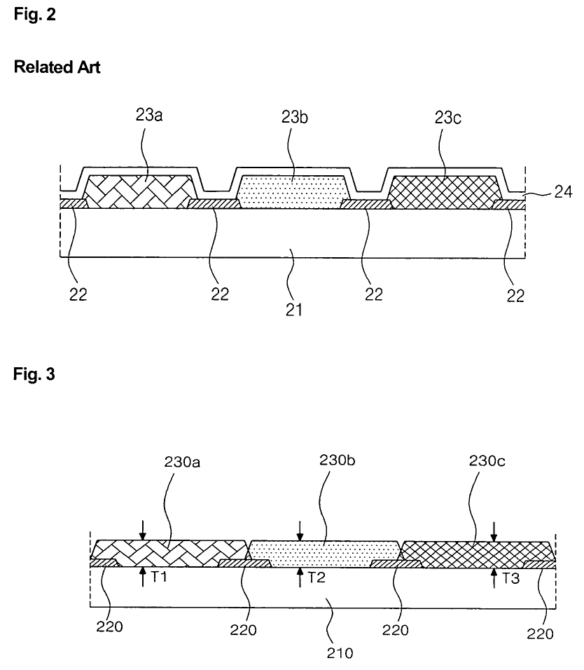

FIG. 3 is a sectional view of a color filter substrate for a liquid crystal display, according to the present invention; and

FIGS. 4a to 4d are sectional views illustrating the fabrication of the color filter substrate for a liquid crystal display according to the present invention.

### DESCRIPTION OF THE ILLUSTRATED EMBODIMENTS

Reference will now be made to an embodiment of the present invention, examples of which are illustrated in the accompanying drawings.

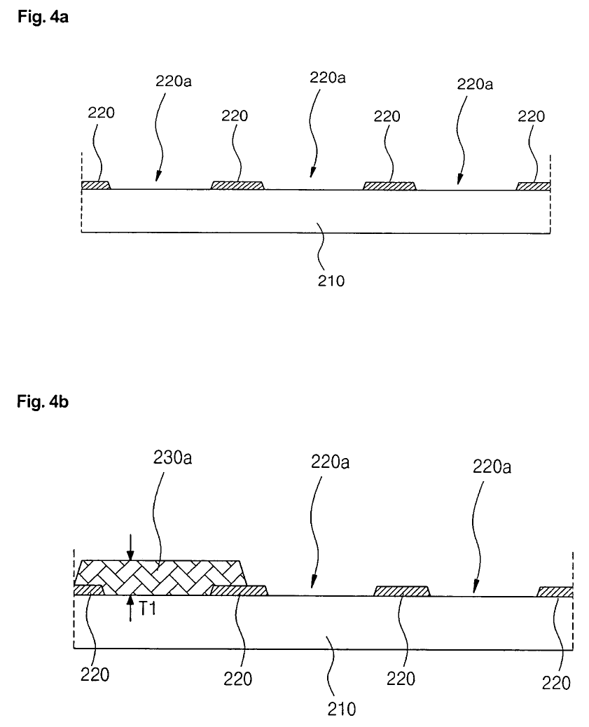

FIG. 3 is a sectional view of a color filter substrate for liquid crystal displays according to the present invention.

In FIG. 3, the color filter substrate for a liquid crystal display according to the present invention comprises a transparent insulating substrate 210, a black matrix 220, red color filter 230a, green color filter 230b, and blue color filter 230c.

The black matrix 220 is formed on the transparent insulating substrate 210, such as glass, at intervals or openings. The black matrix 220 may include chromium (Cr), chromium oxide film (Cr₂O₃), or black resin absorbing light.

Additionally, the red color filter 230a is provided at the openings of the black matrix 220 and include red color resin and transparent conductive material. The green color filter 230b is provided at the openings of the black matrix 220 and include green color resin and transparent conductive material, and the blue color filter 230c is provided at the openings of the black matrix 220 and include blue color resin and transparent conductive material. Meanwhile, the red color filter 230a, the green color filter 230b, and the blue color filter 230c are arranged in an alternating pattern at the openings of the black matrix 220, and are connected to each other on an upper surface of the black matrix 220. Hence, unlike a related art color filter substrate for a liquid crystal display, it is possible to use the red color filter 230a, the green color filter 230b, and the blue color filter 230c including transparent conductive materials, as the common electrode, even though an additional common electrode is not provided on an upper surface of the color filter.

The transparent conductive material included in the red color filter 230a, the green color filter 230b, and the blue color filter 230c may be, for example, ITO (indium tin oxide) or IZO (indium zinc oxide), and the red color filter 230a, the green color filter 230b, and the blue color filter 230c may include transparent conductive material, such as ITO (indium tin oxide) or IZO (indium zinc oxide), in the form of sintered powder. Additionally, the red color filter 230a, the green color filter 230b, and the blue color filter 230c, may, for example, include about 5-35 wt % transparent conductive material, such as ITO or IZO. If the red color filter 230a, the green color filter 230b, and the blue color filter 230c include transparent conductive material, such as ITO or IZO, in an amount less than about 5 wt %, the electric conductivity of the red color filter 230a, the green color filter 230b, and the blue color filter 230c is reduced. Thus, the intensity of the electric field applied to a liquid crystal layer is inefficiently controlled. If the red color filter 230a, the green color filter 230b, and the blue color filter 230c include transparent conductive material, such as ITO or IZO, in an amount more than about 35 wt %, chromaticities of the red color filter 230a, the green color filter 230b, and the blue color filter 230c may be reduced.

The red color filter 230a, the green color filter 230b, and the blue color filter 230c be formed to have a thickness (T1, T2, T3) of about 1-2 mm. When the red color filter 230a, the green color filter 230b, and the blue color filter 230c are formed to have a thickness less than about 1 μm, an electric conductivity of the red color filter 230a, the green color filter 230b, and the blue color filter 230c are reduced. Thus, the intensity of an electric field applied to the liquid crystal layer is inefficiently controlled. Furthermore, when the red color filter 230a, the green color filter 230b, and the blue color filter 230c are formed to have a thickness greater than about 2 μm. The thickness of the color filter substrate increases, thereby increasing the volume of the liquid crystal display.

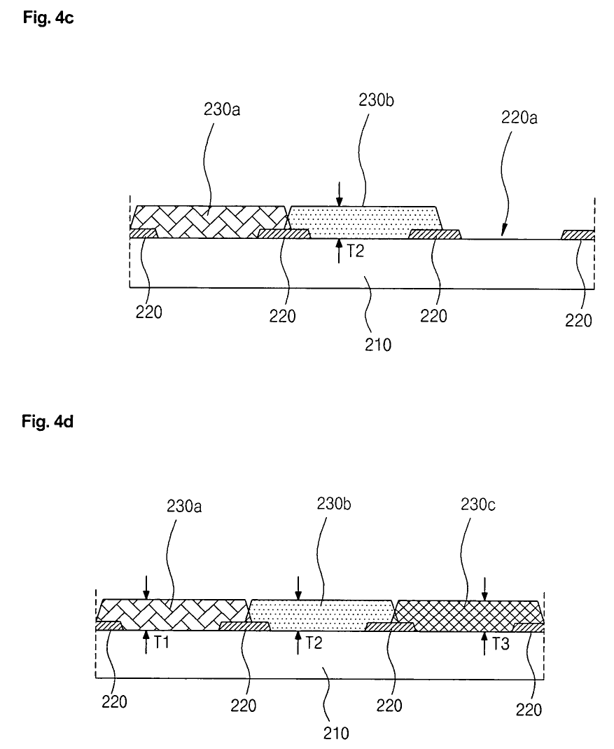

Hereinafter, a detailed description will be given of a method of fabricating the color filter substrate for liquid crystal displays according to the present invention, with reference to FIGS. 4a to 4d. FIGS. 4a to 4d are sectional views illustrating the fabrication of the color filter substrate for liquid crystal displays according to the present invention.

The color filter for liquid crystal displays may be fabricated through a pigment dispersion process, a dyeing process, or an electrode position process. Use of the pigment dispersion process will be described in the present invention. In the pigment dispersion process, which has been frequently used to form the color filter for liquid crystal displays, material in which a polyimide-based pigment is dispersed is applied and exposed to form a pattern. Accordingly, when using the pigment dispersion process, it is possible to form the color filter having improved penetration of light without additional processes.

In FIG. 4a, a black matrix 220 having intervals or openings 220a is formed on a transparent insulating substrate 210, such as glass. In this respect, chromium (Cr) or chromium oxide film (Cr₂O₃) may be deposited and patterned, or black resin absorbing light may be applied and then patterned to form the black matrix 220.

Next, as shown in FIG. 4b, a mixture liquid of sintered powders of red color resin, photosensitive resin, and transparent conductive material is coated on the openings 220a of the black matrix 220, exposed and developed to form the red color filter 230a. A mask (not shown) used during the exposure may have blocking layers which correspond in position to the red color filter 230a. In this case, a positive photosensitive resin, which is to be removed at a portion thereof exposed to light, may be used as the photosensitive resin.

Meanwhile, ITO or IZO may be used as transparent conductive material included in the red color filter 230a. Additionally, the red color filter 230a may include about 5-35 wt % transparent conductive material, such as ITO or IZO. If the red color filter 230a includes transparent conductive material, such as ITO or IZO, in an amount less than about 5 wt %, an electric conductivity of the red color filter 230a is reduced. Thus, the intensity of an electric field applied to a liquid crystal layer is inefficiently controlled. If the red color filter 230a includes transparent conductive material, such as ITO or IZO, in an amount more than about 35 wt %, the chromaticity of the red color filter 230a may be reduced.

The red color filters 230a be formed to have a thickness (T1) of about 1-2 μm. When the red color filter 230a is formed to a thickness less than about 1 μm, the electric conductivity of the red color filter 230a is reduced. Thus, the intensity of an electric field applied to the liquid crystal layer is inefficiently controlled. Furthermore, when the red color filter 230a is formed in a thickness more than about 2 μm, the thickness of the color filter substrate increases, thereby increasing the volume of the liquid crystal display.

Next, as shown in FIG. 4c, a mixture liquid of sintered powders of green color resin, photosensitive resin, and transparent conductive material is coated on the openings 220a of the black matrix 220, exposed and developed to form the green color filter 230b. With respect to this, a mask (not shown) used during the exposure may have blocking layers which correspond in position to the green color filter 230b. In this case, a positive photosensitive resin, which is to be removed at a portion thereof exposed to light, may be used as the photosensitive resin.

Meanwhile, ITO or IZO may be used as transparent conductive material included in the green color filter 230b. Additionally, the green color filter 230b may include about 5-35 wt % transparent conductive material, such as ITO or IZO. If the green color filter 230b includes transparent conductive material, such as ITO or IZO, in an amount less than about 5 wt %, an electric conductivity of the green color filter 230b is reduced. Thus, the intensity of an electric field applied to the liquid crystal layer is inefficiently controlled. Also, if the green color filter 230b includes transparent conductive material, such as ITO or IZO, in an amount more than about 35 wt %, the chromaticity of the green color filters 230b may be reduced.

The green color filter 230b may be formed to have a thickness (T2) of about 1-2 μm. When the green color filter 230b is formed to have a thickness less than about 1 μm, an electric conductivity of the green color filter 230b is reduced. Thus, the intensity of an electric field applied to the liquid crystal layer is inefficiently controlled. Furthermore, when the green color filter 230b is formed to have a thickness more than about 2 μm, the thickness of the color filter substrate increases, thereby increasing the volume of the liquid crystal display.

Next, as shown in FIG. 4d, a mixture liquid of sintered powders of blue color resin, photosensitive resin, and transparent conductive material is coated on the openings 220a of the black matrix 220, exposed and developed to form the blue color filter 230c. With respect to this, a mask (not shown) used during the exposure may have blocking layers that correspond in position to the blue color filter 230c. In this case, a positive photosensitive resin, which is to be removed at a portion thereof exposed to light, may be used as the photosensitive resin.

Meanwhile, ITO or IZO may be used as transparent conductive material included in the blue color filter 230c. Additionally, the blue color filters 230c may include about 5-35 wt % transparent conductive material, such as ITO or IZO. If the blue color filter 230c includes transparent conductive material, such as ITO or IZO, in an amount less than about 5 wt %, an electric conductivity of the blue color filter 230c is reduced. Thus, the intensity of an electric field applied to the liquid crystal layer is inefficiently controlled. Also, if the blue color filter 230c includes transparent conductive material, such as ITO or IZO, in an amount more than about 35 wt %, the chromaticity of the blue color filter 230c may be reduced.

The blue color filter 230c be formed to have a thickness (T3) of about 1-2 μm. When the blue color filter 230c is formed to have a thickness less than about 1 μm, an electric conductivity of the blue color filter 230c is reduced. Thus, the intensity of an electric field applied to the liquid crystal layer is inefficiently controlled. Furthermore, when the blue color filter 230c is formed to have a thickness more than about 2 μm, the thickness of the color filter substrate increases, thereby increasing the volume of the liquid crystal display.

The red color filter 230a, the green color filter 230b, and the blue color filter 230c are arranged in an alternating pattern on the openings 220a of the black matrix 220, and are connected to each other on an upper surface of the black matrix 220. Hence, unlike the related art color filter substrate for liquid crystal displays, it is possible to use the red color filter 230a, the green color filter 230b, and the blue color filter 230c including transparent conductive materials, as the common electrode, even though an additional common electrode is not provided on an upper part of the color filter.

In the method of fabricating the color filter substrate for liquid crystal displays according to the present invention, the formation of the red color filter 230a, the green color filter 230b, and the blue color filter 230c using the positive photosensitive resin is described. However, the formation can be achieved using a negative photosensitive resin in which a portion exposed to light remains. In the above embodiment, after the red color filter 230a is formed, the formation of the green and blue color filters 230b, 230c follows. However, either the green color filter 230b or the blue color filter 230c may be formed first.

The present invention has been described in an illustrative manner, and it is to be understood that the terminology used is intended to be in the nature of description rather than of limitation. Many modifications and variations of the present invention are possible in light of the above teachings. Therefore, it is to be understood that within the scope of the appended claims, the invention may be practiced otherwise than as specifically described.

As described above, in a color filter substrate for liquid crystal displays according to the present invention, because a color filter includes transparent conductive material, it is not necessary to provide an additional transparent electrode. Thus, it is possible to efficiently reduce the fabrication costs of the color filter substrate for liquid crystal display.

Furthermore, in a method of fabricating the color filter substrate for liquid crystal displays according to the present invention, because the color filter includes transparent conductive material, it is not necessary to provide an additional transparent electrode, thus it is possible to efficiently improve the productivity of a process of fabricating the color filter substrate for liquid crystal displays.

It will be apparent to those skilled in the art that various modifications and variations can be made in the present invention without departing from the spirit or scope of the invention. Thus, it is intended that the present invention cover the modifications and variations of this invention provided they come within the scope of the appended claims and their equivalent.

What is claimed is:

1. A color filter substrate for a liquid crystal display, comprising:
a transparent insulating substrate;
a black matrix on the transparent insulating substrate and having a plurality of openings;
a red color filter on one of the openings of the black matrix, wherein the red color filter includes a red color resin and a transparent conductive material;
a green color filter on a second another of the plurality openings of the black matrix, wherein the green color filter includes a green color resin and the transparent conductive material; and
a blue color filter on a third of the plurality of openings of the black matrix, wherein the blue color filter includes a blue color resin and the transparent conductive material.

2. The color filter substrate as set forth in claim 1, wherein the red color filter, the green color filter, and the blue color filter are connected to each other on an upper side of the black matrix.

3. The color filter substrate as set forth in claim 1, wherein each of the red color filter, the green color filter, and the blue color filter includes the transparent conductive material in a sintered powder form.

4. The color filter substrate as set forth in claim 1, wherein the transparent conductive material is indium tin oxide (ITO) or indium zinc oxide (IZO).

5. The color filter substrate as set forth in claim 1, wherein each of the red color filter, the green color filter, and the blue color filter includes about 5-35 wt % transparent conductive material.

6. The color filter substrate as set forth in claim 1, wherein each of the red color filter, the green color filter, and the blue color filter is formed to have in a thickness of about 1-2 μm.

7. A method of fabricating a color filter substrate for a liquid crystal display, comprising:
providing a transparent insulating substrate;
forming a black matrix having a plurality of openings on the transparent insulating substrate; and
forming a red color filter, including a red color resin and a transparent conductive material, a green color filter including a green color resin and the transparent conductive material, and a blue color filter including a blue color resin and the transparent conductive material on the openings of the black matrix.

8. The method as set forth in claim 7, wherein the red color filter, the green color filter, and the blue color filter are connected to each other on an upper side of the black matrix.

9. The method as set forth in claim 7, wherein the red color filter, the green color filter, and the blue color filter include the transparent conductive material in a sintered powder form.

10. The method as set forth in claim 7, wherein the transparent conductive material is indium tin oxide (ITO) or indium zinc oxide (IZO).

11. The method as set forth in claim 7, wherein each of the red color filter, the green color filter, and the blue color filter includes 5-35 wt % transparent conductive material.

12. The method as set forth in claim 7, wherein each of the red color filter, the green color filter, and the blue color filter is formed in a thickness of 1-2 μm.
